(19) United States
(12) Patent Application Publication
(10) Pub. No.: US 2007/0022167 A1
(43) Pub. Date: Jan. 25, 2007

(54) Personal email linking and advertising system

(76) Inventor: James Citron, Burbank, CA (US)

Correspondence Address: MUSKIN & CUSICK LLC, 1800 CALLOWHILL ST, SUITE 200, PHILADELPHIA, PA, 19130, US

(21) Appl. No.: 11/259,548

(22) Filed: Oct. 25, 2005

Related U.S. Application Data
(60) Provisional application No. 60/700,528, filed on Jul. 19, 2005.

(51) Int. Cl. G06F 15/16

(52) U.S. Cl. 709/206

(57) ABSTRACT

An e-commerce system wherein an email can automatically be embedded with hyperlinks of merchant and/or informational sites of interest. When a receiver of the email clicks any of the hyperlinks and makes a purchase, the sender of the email can be rewarded with points. Points may additionally be awarded to the sender and/or receiver if the receivers clicks through to a linked site (without a purchase). Points may also be awarded to the sender and/or receiver if the receiver forwards the email on to other recipients, who may be awarded points in the same fashion, and this process can continue infinitely. The points can be redeemed for rewards at a later time by the sender and/or receivers of the email.

### CROSS REFERENCE TO RELATED APPLICATIONS

This application claims benefit to provisional application no. 60/700,528, filed on Jul. 19, 2005, which is incorporated by reference herein in its entirety.

### BACKGROUND OF THE INVENTION

1. Field of the Invention

The present invention is directed to a method, apparatus, and computer readable storage medium directed to automatically embedding hyperlinks into an email and offering incentives to purchase products through the hyperlinks.

2. Description of the Related Art:

Email is currently a very common mode of communication. Currently, when a sender sends an email, he or she does not expect to make any profit from the email.

What is needed is an email system wherein email communication may be made yet more engaging and exciting by allowing end-users the possibility of more rapid and meaningful access to products and services, with little or no effort on their part.

### SUMMARY OF THE INVENTION

It is an aspect of the present invention to provide a system to encourage e-commerce and reward participants.

The above aspects can be obtained by a method that includes (a) scanning an email message written by a sender for a plurality of keywords; (b) automatically embedding a hyperlink in the plurality of keywords; and (c) transmitting the email message to a receiver.

The above aspects can also be obtained by a computer readable storage that can perform (a) scanning an email message written by a sender for a keyword; (b) automatically embedding a hyperlink in the keyword; and (c) transmitting the email message to a receiver.

The above aspects can also be obtained by an apparatus that includes (a) a sender composing an email; (b) a sender's client automatically embedding a plurality of hyperlinks in selected keywords in the email; (c) a receiver receiving the email and clicking a particular hyperlink of the hyperlinks, visiting a web site of a merchant associated with the particular hyperlink, and making a purchase at the merchant; (d) a merchant receiving the purchase by the receiver and processing the purchase and transmitting transaction information to a reward server; and (e) a reward server receiving the transaction information from the merchant and accumulating points in a record associated with the sender.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing an e-commerce system, according to an embodiment;

FIG. 2 is a block diagram illustrating participants to the e-commerce system, according to an embodiment;

FIG. 3 is a flowchart illustrating an exemplary method of automatically embedding hyperlinks into an email, according to an embodiment;

FIG. 4A is an example of an original composed email message, according to an embodiment;

FIG. 4B is an example of the email message with hyperlinks embedded therein, according to an embodiment;

FIG. 5A is a flowchart illustrating an exemplary method of processing a purchase by a merchant, according to an embodiment;

FIG. 5B is a flowchart illustrating an exemplary method of processing a transaction by a reward server, according to an embodiment;

FIG. 5C is a flowchart illustrating an exemplary method of allowing a sender to earn rewards, according to an embodiment;

FIG. 5D is a flowchart illustrating an exemplary method of accounting for a receiver clicking a link, according to an embodiment;

FIG. 6 is a diagram illustrating an exemplary output of a reward system, according to an embodiment; and

FIG. 7 is a flowchart illustrating an exemplary method of forwarding and tracking participants, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a method, system, and computer readable storage which allows a sender and (also a receiver) to profit from the email process.

This can be accomplished by allowing a sender to compose an email message, and before the message is actually transmitted, hyperlinks can be automatically embedded into the message. The hyperlink can take the receiver of the email to an online store, wherein when the receiver clicks the hyperlinks and makes a purchase (although depending on the embodiment, a purchase may not be necessarily required to earn rewards), the sender can then earn points for the purchase. The sender can then earn awards based on his or her points. Alternatively, the hyperlink can take the receiver of the email to a web page that is information that has no products for sale. The sender can still be rewarded if the receiver clicks such a link and visits an informational page without making a purchase.

In a further embodiment, the receiver can earn points or awards just by clicking on links received by the sender (with a purchase mandatory or optional depending on the embodiment). The receiver can also forward the email to others wherein the forwarding person can also earn rewards (as well as possibly the original sender as well) similarly to the original sender.

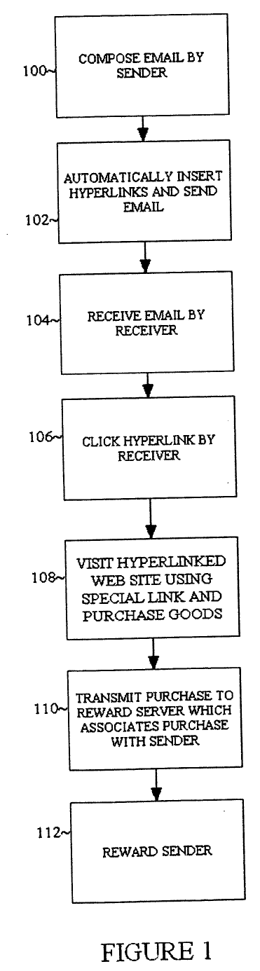

FIG. 1 is a flowchart illustrating an exemplary method of implementing an e-commerce system, according to an embodiment.

The method can begin with operation 100, wherein a sender composes an email.

From operation 100, the method can proceed to operation 102, which automatically inserts hyperlinks into the email and then sends the email. This process will be discussed below in more detail.

From operation 102, the method can proceed to operation 104, wherein a receiver receives the email sent by the sender.

From operation 104, the method can proceed to operation 106, wherein the receiver clicks one of the automatically embedded hyperlinks. The embedded hyperlinks can be an identifiable link which can have a special code to identify the sender, similar to an affiliate link as known in the art.

From operation 106, the method can proceed to operation 108, wherein the receiver visits, typically via his or her web browser, pointed to by the clicked hyperlink and the receiver then makes a purchase on that site. In an alternative embodiment, making a purchase may not be required.

From operation 108, the method can proceed to operation 110, which transmits the purchase to a reward server. A reward server can be a separate database/server which can receive transaction information from merchants and tabulate the transaction information. The transaction information can include the item(s) purchased and their respective amounts, the identity of the sender (using the identifiable link) and/or receiver (using information obtained by the merchant for processing the purchase), and any other information related to the receiver's purchase.

The reward server will tabulate the purchase. For example, a record can be associated with the receiver and that record can reflect the receiver's purchase. If a purchase wasn't made, transaction information can still be transmitted (e.g. page visited, time, sender's and receiver's identification, etc.) as described, but without actual purchase information

From operation 110, the method can proceed to operation 112, which rewards the sender for instigating the purchase by the receiver. More on the reward process will be discussed below in more detail.

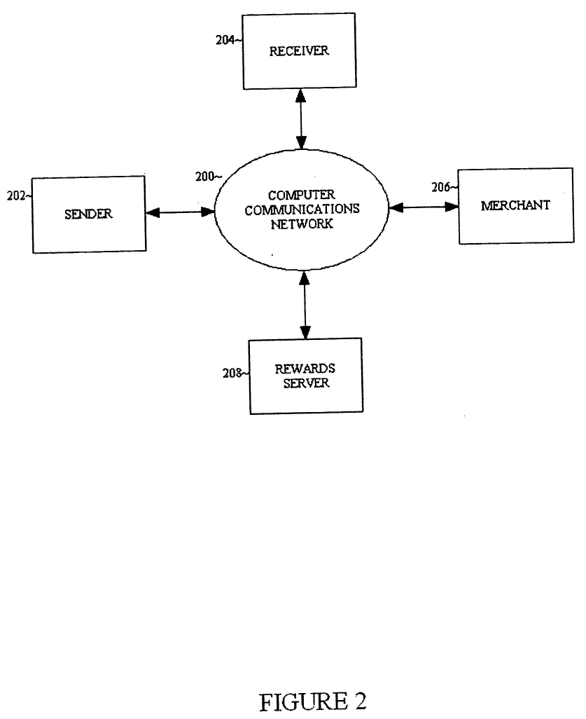

FIG. 2 is a block diagram illustrating participants to the e-commerce system, according to an embodiment.

A computer communications network 200 such as the Internet can be used to coordinate any and all transactions transmissions as described herein, although of course other networks can be used as well.

A sender 202 can transmit his or her message to the receiver 204 using the computer communications network 200. Both the sender 202 and the receiver 204 can use standard software clients which may contain additional software to effectuate any of the embodiments described herein. A merchant 206 can also be connected to the computer communications network as well as a reward server 208.

Typically, the sender 202 transmits (an email message) to the receiver 204, who in turn communicates (receives web sites and makes purchase) with the merchant 206 who in turn can communicate (transmits transaction information) with the rewards sever 208. The sender can also communicate with the rewards server 208 to view and redeem his or her awards.

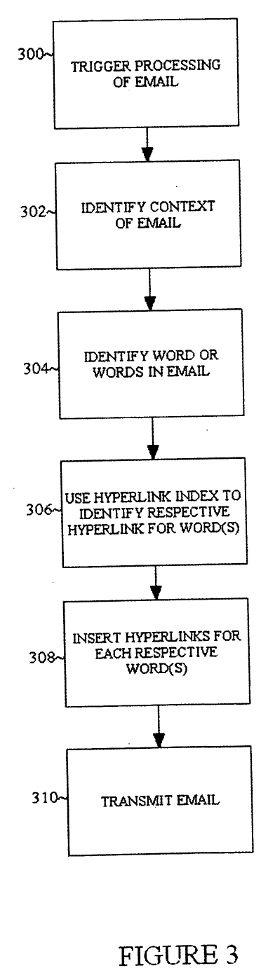

FIG. 3 is a flowchart illustrating an exemplary method of automatically embedding hyperlinks into an email, according to an embodiment.

The method can begin with operation 300, which triggers a processing of an email message. For example, this can be accomplished when a sender presses a “send” button on his or her email client.

From operation 300, the method can proceed to operation 302, which can be optional. If operation 302 is not included in an implementation, then the method can simply proceed from operation 300 to operation 304.

Operation 302 determines a context of the message. This can be helpful (although not required) to determine more appropriate hyperlinks to embed. Determining a context can be performed by parsing words in the email message, associating each word with a category, and selecting a category with the most words associated with it. For example, Table I illustrates words and their respective categories. Of course this table is very short for illustrative purposes, although a larger such table is recommended for actual use. Categories can also be represented by numbers in digital format.

TABLE I

| word | category |
|---|---|
| cat | animals, pets |
| dice | gambling |
| las vegas | las vegas |
| paris | las vegas, France |
| plane | travel, vacation |

Consider a one line email which contains the words, “I am ready to board the plane to Las Vegas where I can't wait to play dice at the Paris.” Words which are not in the table (or index) can be ignored. Thus, the word “plane” adds one to the categories: travel, vacation. The word “Paris” adds one to the categories: Las Vegas, France. The word “dice” adds one to the category gambling. The words “Las Vegas” add one to the category: Las Vegas. Thus, the category totals are: gambling: 1, Las Vegas: 2, France: 1, travel: 1, vacation: 1. Thus, since the category Las Vegas has the highest total, the context of the email can be considered to be Las Vegas.

From operation 302, the method can proceed to operation 304, which identifies a word or words in the email. This can be done by parsing words or blocks of words looking for a delimiter (typically a space).

From operation 304, the method can proceed to operation 306, which uses a hyperlink index to identify respective hyperlink for word(s). This embeds hyperlinks into words of the email. This can be performed using a hyperlink index. Table II illustrates on example of a hyperlink index (which is not context sensitive). Please note that any URLS identified herein are merely for illustrative purposes and are not intended to invoke any content on any URLS.

TABLE II

| word | hyperlink |
|---|---|
| paris casino hotel | www.pariscasino.com |
| paris | www.paristravel.com |
| Cat | www.catlovers.com |

Thus, any instance of a word in the word column can be embedded with a hyperlink in the hyperlink column. Note that the word is not replaced, and the text of the email should typically remain the same. Hyperlinks are embedded, which means when certain words are clicked then the receiver's browser will then take them to that web site. The only difference in appearance from a word before it is processed and after a hyperlink is embedded is that the latter may be underlined and in a different color and/or font.

The hyperlink index in Table II is not context sensitive, in that the context of the email is not relevant as to which links are embedded. A context sensitive method may produce more accurate results. Table III is a context sensitive hyperlink index,

TABLE III

| word | context | hyperlink |
|---|---|---|
| paris | las vegas | www.pariscasino.com |
| paris | france, default | www.paristravel.com |
| cat | any | www.catlovers.com |

Thus, in the previous example, since the one line email was determined to have the context of “Las Vegas”, from Table III, the word Paris with the category “Las Vegas” gets the hyperlink of www.pariscasino.com. Note that words can also have defaults if the category of the email does not match a particular entry. For example, if the category of an email is pets, then the default hyperlink for the word “Paris” would be www.paristravel.com.

Thus, in the previous one line email example, the word “Paris” would link to the Paris Casino Hotel as opposed to a link related to the city in France. Thus, using the context sensitive approach may result in more accurate results, although it is not required.

Note that automatically inserted links should also contain a code to identify each sender. This code can be used by the merchant to submit the transaction information to a reward server in order to record and tabulate the transaction. An example of an identifiable link might be. www.samplelink.com/Q33443, wherein Q33443 might be a code to identify a particular participant.

From operation 306, the method can proceed to operation 308, which inserts (or embeds) a hyperlink for each respective word. This can be done by replacing the word in the email with an html code which contains the hyperlink while the original word still appears intact to the user. The actual URL of the link may be invisible to receiver of the email until he or she clicks a hyperlink, or the URL may be placed besides the keyword, e.g. Paris (www.pariscasino.com).

Once all the processing of the email message is performed, the method can proceed to operation 310, which transmits the email. This can be done as known in the art. The receiver's email client should ideally support html format in order for the receiver to be able to simply click any hyperlinks (although other (non html) formats can be supported by the sender/receiver as well).

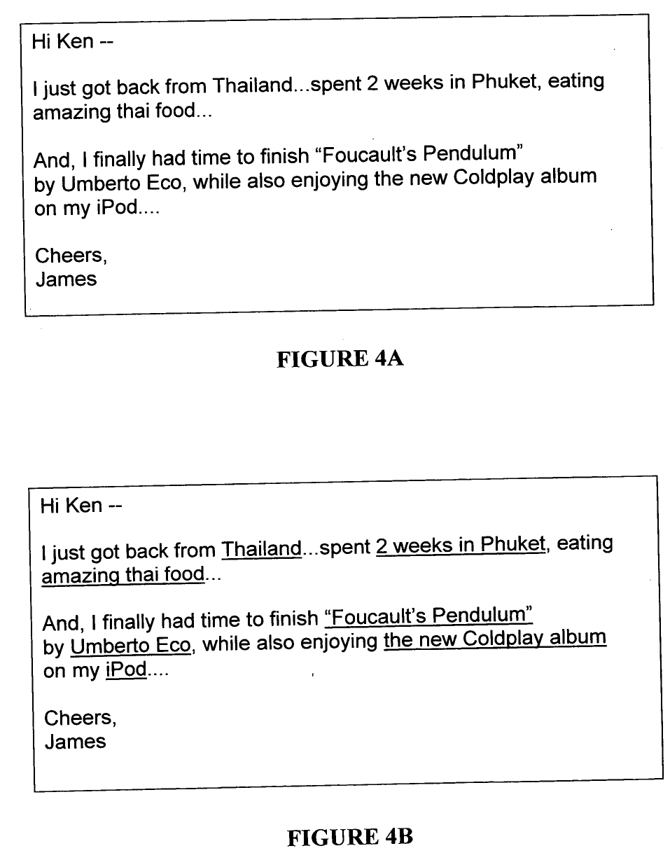

FIG. 4A is an example of an original composed email message, according to an embodiment.

FIG. 4B is an example of the email message with hyperlinks embedded therein, according to an embodiment. Note that hyperlinks are embedded in certain words. The hyperlinks should ideally be linked to web sites which offer products which the receiver is likely to purchase from. For example, the words, “amazing Thai food” may link to an online Thai grocery store where the receiver will hopefully make a purchase.

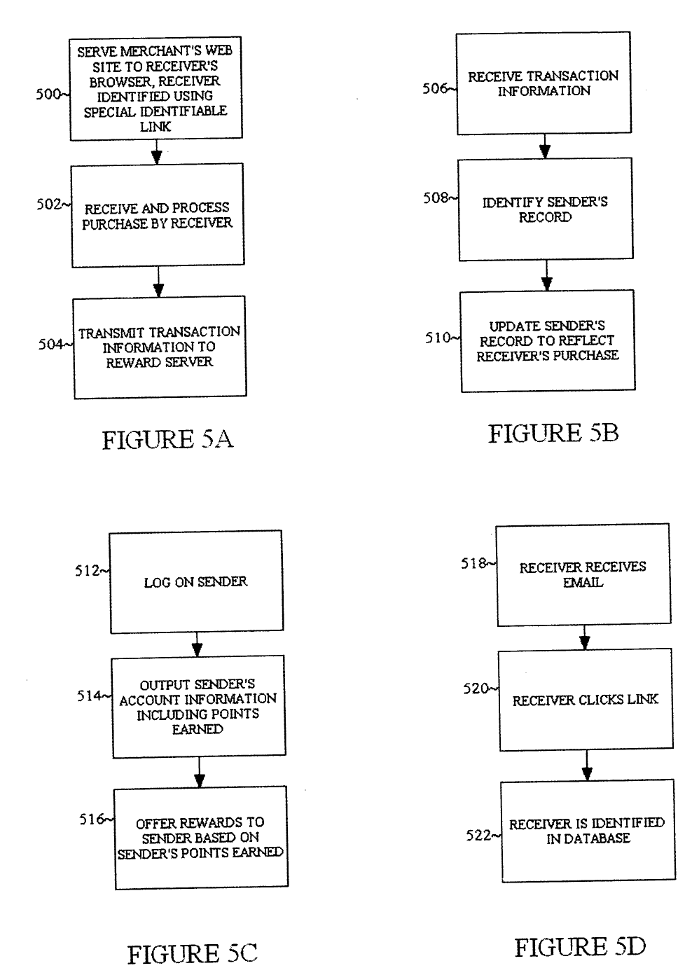

FIG. 5A is a flowchart illustrating an exemplary method of processing a purchase by a merchant, according to an embodiment.

The method can begin with operation 500, which is effectuated when a receiver of an email message as processed herein clicks an automatically inserted (by the sender's client) embedded hyperlink and visits the linked web site. Operation 500 can serve the content of the merchant's web site to the receiver's web browsing client. The merchant also receives an identifiable link (which includes code to identify the sender).

From operation 500, the method proceeds to operation 502, which receives and processes a purchase by the sender. This can be done as known in the art, wherein the receiver may give his credit card information and make his purchase.

From operation 502, the method can proceed to operation 504, which transmits transaction information to reward server. The transaction information can comprise any information related to the transaction, including the sender's identity (can be his or her code from the identifiable link), the item(s) purchased, amounts, etc. Alternatively, to protect the receiver's privacy, the information may, for example, be limited to the amount purchased and the sender's identity.

After the purchase is made by the receiver and the information transmitted to the reward server as illustrated in FIG. 5A, the reward server should appropriately process the information received.

FIG. 5B is a flowchart illustrating an exemplary method of processing a transaction by a reward server, according to an embodiment.

The method can start with operation 506, which receives the transaction information from the merchant (receives the information transmitted in operation 504).

From operation 506, the method can proceed to operation 508, which identifies sender's record. One way this can be done is to use a code identifying the sender (received in operation 506) to index records in the reward server database. This code (e.g. “Q33443”) can be transmitted by the merchant (who has received the code from the hyperlink used by the receiver). A record should exist for each participant which comprises that participant's points earned, etc. Note that each sender and/or receiver may have to initialize an account before enjoying the benefits of the system. Such initialization would accept the sender's and/or receiver's personal information (e.g. name, address, etc.) and assign this user a code which can then be embedded in hyperlinks. When this code is received in operation 508, the reward server can then use this code as an index to identify the sender's and/or receiver's record (account).

From operation 508, the method can proceed to operation 510, which updates the sender's record to reflect the receiver's purchase. A tally of points earned by the receiver can be kept in the receiver's record, and the points can be increased to reward the sender for the receiver's purchase. If the sender does not make a purchase, then (in an embodiment) by the receiver simply clicking the link, the sender and/or the receiver (depending on the embodiment) can earn points (typically less than if a purchase was made). The points can be accumulated in a number of ways, for example the points can simply accumulate the dollar amount of every purchase associated to that sender. Alternatively, the points can accumulate a constant times the dollar amount of a purchase (e.g. 1 point=$100 in sales). Alternatively, the point total can simply be increased by one for each sale (regardless of the purchase price). Alternatively, any algorithm and/or proportions for awarding points may be used to reward the sender and possibly the receiver for participating in the system.

In a further embodiment, the sender can also earn points for embedding links in his or her email, even if the receiver does not click them. In an embodiment, the sender will receiver more points if the receiver clicks the link(s), and even more points if the sender makes a purchase on the linked to site.

When a sender and/or receiver has accumulated points, the sender and/or receiver may wish to view and possibly redeem those points. This can be done by logging onto the reward server.

FIG. 5C is a flowchart illustrating an exemplary method of allowing a sender to earn rewards, according to an embodiment.

The method can start with operation 512, which logs on the sender. The sender can log on using any known such method, which may include using a username, password, etc.

From operation 512, the method can proceed to operation 514, which outputs to the sender the sender's account information, including points earned and any other related information.

From operation 514, the method can proceed to operation 516, which offers the sender rewards based on the number of points the sender has earned. For example, for every point the sender has earned, the sender can receive a discount off an affiliated product (e.g. an airline ticket). Alternatively, points can be redeemed for cash (e.g. every 100 points=$1 cash). Alternatively, items can be exchanged for points, for example a toaster can be sent to the sender in exchange for 200 points.

An output screen served by the reward server can be displayed to a remote sender using the sender's web browser (or downloadable client).

In an embodiment, the receiver may also be rewarded for clicking a link sent by the sender (although rewarding the receiver is optional). For example, if a sender sends an email to a receiver with an embedded link, and the receiver clicks that link (even though he or she does not buy anything), the receiver may be entitled to points as well. If the receiver actually buys something at the linked to page (or site), then the receiver may be entitled to points (or more points than if the receiver merely visited the site).

FIG. 5D is a flowchart illustrating an exemplary method of accounting for a receiver clicking a link, according to an embodiment.

The method can start with operation 518, wherein the receiver receives an email from the sender. This is similar to operation 104.

From operation 518, the method can proceed to operation 520, wherein the receiver clicks a clink in the received email. This is similar to operation 106.

Form operation 520, the method can proceed to operation 522, wherein the receiver is identified to database, along with additional information about the receiver's visit (e.g. which page visited, any purchases, etc.)

When the receiver clicks a page the receiver and his or her actions can be identified in numerous ways. The receiver may be required to initially subscribe to the system described herein, which may require him to download client software on the receiver's computer. With this software running in the background, whenever the receiver clicks a link, the software can determine whether the link is one receiver in an email that is part of the system (for example by storing such received links by email in a list or database) and then transmits the click to a database such as the rewards server 208.

Everyone who opts into the system can have some type of code. Each email that is part of the system can also have codes as well as the hyperlinks which can be inserted into an email. Email clients on the sender and receiver side can insert and parse these codes and transmit relevant data to a database (such as the rewards server) 208 which can track all transactions related to the emails.

The rewards server can also identify the sender in numerous ways, such as an identifying code on the receiver's link. An application running in the background on the sender's computer can also transmit the email to a database such as the rewards server 208. When the receiver purchases something (or visits a page), the merchant site (or non-merchant site host) can transmit details to the rewards sever 208 (which can also include the identity of the receiver, who can be identified by information the receiver fills out to make a purchase (or page view), or by any other method including those described herein).

Another method clicks can be tracked is that for each click (either by sender, receiver, or both), a text file is stored (either locally on each party's computer or on a remote storage), which can be appended to based on the click activity. For example, when an email is sent by a sender, a text file is created on a storage (which can be indexed by a unique identifier for the email). When the receiver clicks a link, software running in the background on the receivers computer (running at a later time such as upon startup), can append to the text file details of what the receiver did (e.g. click, etc.). The merchant (or non-merchant site host) can also append to this file details of any transaction. When a receiver clicks a link, the receiver's computer can remotely create a text file in which the merchant site (or non merchant site host) can retrieve (or can index in a number of ways, such as receiver IP address) the text file, and append to it confirmation that the receiver actually visited, and this file can then be retrieved by (or transmitted to) the rewards server to confirm the receiver's click (and potential purchase if applicable).

Thus, the sender and receiver of the link that the receiver clicked being identified, the rewards server 208 can attribute any points to either or both parties for the transaction (page view, purchase, etc.)

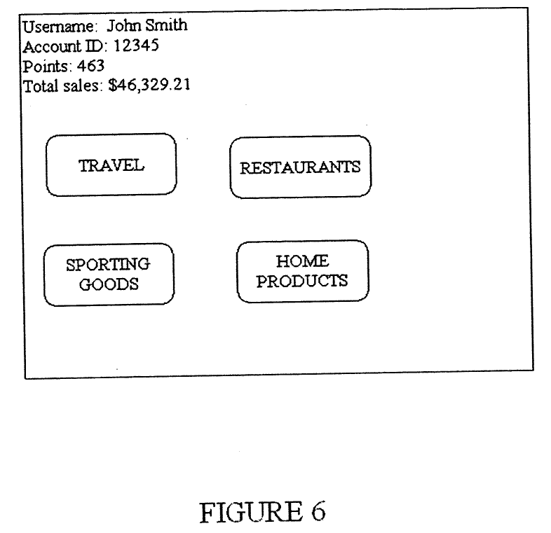

FIG. 6 is a diagram illustrating an exemplary output of a reward system, according to an embodiment.

The output can include any combination of the following: the sender's name, his account ID, his points earned, the total sales associated to the sender's account, and/or any other information related to the sender's account.

The output can also contain links to other pages which can then be used by the sender to redeem rewards (e.g. travel, restaurants, sporting goods, home products, or any category of products or services). The sender can click any of these links wherein individual products can be displayed with the number of points needed to redeem them. The sender can then redeem these items if he chooses to and has enough points.

When a receiver receives an email from the sender, the receiver may wish to forward the email on to another recipient. The receiver can earn points this way and the receiver now becomes in a sense a sender (and thus all operations involving a “sender” as described herein can now be applied to the receiver become sender).

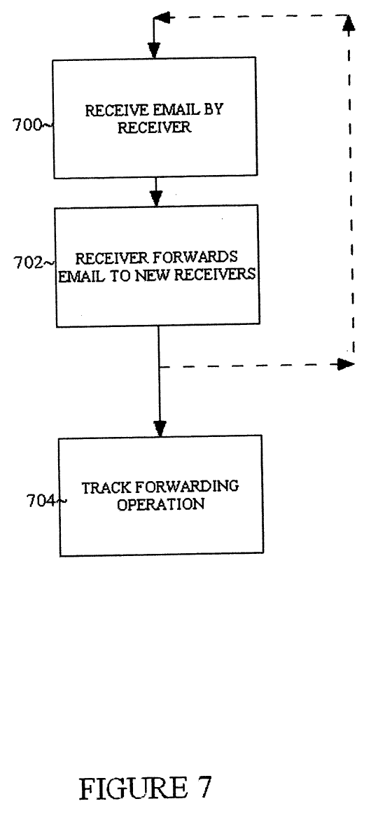

FIG. 7 is a flowchart illustrating an exemplary method of forwarding and tracking participants, according to an embodiment.

The method can begin with operation 700, which receives an email by a receiver. This is similar to operation 104.

From operation 700, the method can proceed to operation 702, wherein the receivers forwards the email to new receivers. The forwarding can be accomplished by pressing a “forward” button on the sender's email client as known in the art. The receiver may be using (may be optional or required depending on the embodiment being implemented) a special e-mail client which may be required in order for the receiver to participate in receiving rewards.

Note that the new receivers can receive the email and in turn forward the email to new receivers. A new receiver in operation 702 can then be considered a receiver in operation 700, who can then forward the email to new receivers in operation 702. This process can continue indefinitely, or the system may place a cap on the number of parties in a chain of emails that will be tracked and rewarded.

From operation 702, the method can proceed to operation 704, which tracks the forwarding operation in a database (such as the rewards server 208). This operation may be optional. This operation can be accomplished by any method descried herein or known in the art. For example, the email client on the receiver's computer can transmit to the database, such as the rewards server 208, (any one or combination of): the identity of the original sender, the receiver, and the new receivers, the links contained in the email (including any special identifying link or code associated with each link), and a special unique identifier identifying the particular email. Thus, whenever any receiver (the original receiver or new receivers) clicks a link (the “clicker”), the linked to site can transmit an identity of the clicker (as well as the site). The database can find a record containing any combination of: the clicker, and other details of the email, such as the original sender, any receivers of the email, and parties in a sending chain from the original sender to the clicker.

For example, if party A composes an email (which gets automatically embedded hyperlinks as described herein using an identifying code) and sends it to party B (this send may be tracked in a database by A's client software who can send information of the email to the database, although a transmission to a database by party A may be optional). Party B in turn forwards it to parties C and D (an optional email client on B's computer can track the forward of the email to parties C and D and transmit this to the database). Party D forwards the email to party E (an optional email client on D's computer can track the forward of the email to party E and transmit this to the database) who clicks a link on the email and makes a purchase (although a purchase is not required). When the purchase is made, the merchant server can transmit an identifying code (such as that found on the link E used to reach the merchant site) to the database which may be used to identify party A, B, C, D and E. Parties A, B, D and E may be rewarded for the click (and optionally party C for being a recipient of the email). Party C may be left out of the rewards though because the click by party E had really nothing to do with party C, so any rewards available from party E's transaction should be split among parties that contributed to the transaction. In an embodiment, each transmission to the database may use a special identifier assigned to the email by the original sender (which may also be embedded in the link), or just a code in the link itself so that the database knows which email the information relates to.

One method all of these transactions can be tracked is that client software can be running on all participants (optionally including the merchant or non-merchant host web sites), and each action (receiving an email participating in the system, sending an email participating in the system, clicking on a link which has a link to be tracked by this system, and any transactions occurring at the linked to site), can all be tracked by background software and transmitted to a database such as the rewards server 208 so that participants can be respectively rewarded. Each email can have a unique ID number and any action related to each email can be indexed in a file or record for the respective email.

In a further embodiment, a sender and/or receiver can opt in or out of the system on a per-email basis. For example, if the sender does not wish a particular email to participate (e.g. automatically embed links which can earn senders and/or receivers points), then he can click a button to opt out (or in). Likewise, a receiver could click a button on his/her email client which can both eliminate any automatically embedded links an email may have, and may also not track any clicks by the receiver. Automatically embedded links can be identified, for example, by a special code in each automatically embedded link. If a sender or receiver opts out of the system, the system can still allow senders and/or receivers to receive links inserted manually by the sender. Each participant (both senders and/or receivers) has enrolled at some point, may receiver a unique ID, and may cancel/suspend his or her account at any time.

Thus, described is a system wherein a sender of an email can automatically embed hyperlinks which are desirable for a receiver of the email to click. The hyperlinks can bring the receiver to a web site wherein the receiver can make purchases. The sender will be rewarded for these purchases. The sender and/or receiver may also be rewarded if the receiver clicks a link without making a purchase (the reward may be less). The sender and/or receiver may also be rewarded if the receiver forwards the email on to other recipients. A sender (or forwarded) may also earn points for every further person down the chain that visits a hyperlinked site and/or forwards such links to further users. A forwarder can be considered a sender regarding the descriptions herein, and any processes described used for sending emails can also be used for forwarding. The system can also track all forwarders (senders) as well as the original sender by transmitting such information from the email clients to the rewards server.

Thus, senders and/or receivers of emails can profit simply from sending emails with little effort on their part. Internet merchants (and also informational web sites) can also benefit from the increased traffic and greater incentives to visit these sites.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method comprising:
scanning an email message written by a sender for a plurality of keywords;
automatically embedding a hyperlink in the plurality of keywords; and
transmitting the email message to a receiver.

2. A method as recited in claim 1, further comprising:
receiving the email message by the receiver;
clicking the hyperlink by the receiver; and
browsing, by the receiver, a web site associated with the hyperlink.

3. A method as recited in claim 3, further comprising:
making a purchase by the receiver at the web site.

4. A method as recited in claim 3, further comprising:
transmitting transaction information by the web site related to the purchase to a reward server;
accumulating send points associated with the sender; and
allowing the sender to redeem awards by using the points.

5. A method as recited in claim 4, further comprising:
accumulating receiver points associated with the receiver related to the purchase; and
allowing the receiver to redeem awards by using the receiver points.

6. A method as recited in claim 1, wherein the hyperlink is automatically selected based on a context of the email message.

7. A method as recited in claim 1, wherein the hyperlink contains a link with a identifiable code identifying the sender.

8. A method as recited in claim 2, further comprising:
forwarding, by the receiver, the e-mail to a new receiver;
clicking the hyperlink by the new receiver;
purchasing a product, by the new receiver, on the web site associated with the hyperlink;
rewarding the sender and the receiver for the purchasing of the product by the new receiver.

9. A method as recited in claim 8, further comprising, rewarding the new receiver for the purchasing of the product.

10. A method as recited in claim 8, further comprising, rewarding the receiver for the purchasing of the product by the new receiver.

11. A method as recited in claim 8, further comprising, rewarding the sender for the purchasing of the product by the new receiver.

12. A method as recited in claim 2, further comprising:
transmitting transaction information by the web site related to the browsing by the receiver to a reward server;
accumulating send points associated with the sender; and
allowing the sender to redeem awards by using the points.

13. A method as recited in claim 12, further comprising:
accumulating receiver points associated with the receiver related to the browsing by the receiver; and
allowing the receiver to redeem awards by using the receiver points.

14. A method as recited in claim 12, wherein the send points would be higher if the receiver made a purchase at the web site as opposed to browsing at the web site.

15. A method as recited in claim 13, wherein the receiver points would be higher if the receiver made a purchase at the web site as opposed to browsing at the web site.

16. A computer readable storage medium to automatically embed hyperlinks, the medium controlling a computer by:
scanning an email message written by a sender for a keyword;
automatically embedding a hyperlink in the keyword; and
transmitting the email message to a receiver.

17. An apparatus to facilitate e-commerce, the apparatus comprising:
a sender composing an email;
a sender's client automatically embedding a plurality of hyperlinks in selected keywords in the email;
a receiver receiving the email and clicking a particular hyperlink of the hyperlinks, visiting a web site of a merchant associated with the particular hyperlink, and making a purchase at the merchant;
a merchant receiving the purchase by the receiver and processing the purchase and transmitting transaction information to a reward server; and
a reward server receiving the transaction information from the merchant and accumulating points in a record associated with the sender.

18. An apparatus as recited in claim 17, wherein the sender can log onto the reward server and redeem a reward by exchanging points for the reward.

19. An apparatus as recited in claim 17, wherein the particular hyperlink contains a link with a code identifying the sender.
